(19) United States
(12) Patent Application Publication
(10) Pub. No.: US 2007/0082189 A1
(43) Pub. Date: Apr. 12, 2007

(54) Waterproof, breathable composite material

(76) Inventor: William J. Gillette, Fort Collins, CO (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 11/248,034

(22) Filed: Oct. 11, 2005

(51) Int. Cl. B32B 5/24; B32B 3/26; B32B 3/00; B32B 5/18; B32B 9/00

(52) U.S. Cl. 428/304.4; 428/314.4; 428/318.4; 442/370; 442/373

(57) ABSTRACT

A composite material that may be used to form, among other things, sports clothing, such as jackets, gloves, boots or fishing waders, is waterproof, breathable and insulated. The composite material includes at least an insulating layer of open-cell foam a waterproof layer on one side of the insulating layer. The composite material also preferably includes a protective layer on the side of the insulating layer opposite the waterproof layer. The composite material may have additional layers on either side or both sides of the insulating layer. The open-cell foam of the insulating layer is preferably, but not necessarily, a thermoplastic that can be re-shaped through the use of a thermal forming process.

### FIELD OF THE INVENTION

The present invention relates to materials that are waterproof, insulated and breathable. Such a covering may be used to form sports clothing, such as fishing waders and boots.

### BACKGROUND OF THE INVENTION

Technical developments in the sports clothing industry have resulted in the use of engineered textiles for specialized performances in different sports. With high-functional and smart materials providing a strong focus in the textile industry generally, companies are increasingly looking for ‘value added’ textiles and functional design in sportswear.

Traditionally, materials that require water resistance plus insulation against the cold include or are entirely comprised of a solid rubber layer, such as neoprene rubber, which is the name for a family of synthetic rubbers based on polychloroprene. This neoprene material, although waterproof cannot ‘breathe’ or vent water vapor, such as warm body moisture (perspiration) of a wearer to the outside.

When excess body moisture cannot escape, it accumulates within the garment and creates a clammy feeling, can soak the garment (and/or user) with perspiration that leads to discomfort and potential heat loss.

The following are other known waterproof materials used to manufacture sports clothing, such as waders: expanded PTFE film, i.e. GORE-TEX, and eVENT. While these materials are waterproof, they provide little or no thermal insulation and a user must wear one or more layers of fabric (such as thermal underwear and/or socks) under the material to attempt to stay warm.

### SUMMARY OF THE INVENTION

The invention is a breathable, insulated, waterproof composite material that includes an insulating layer that allows body moisture to escape, or vent from, the material. The material is comprised of more than one layer and preferably includes (1) an insulated layer of open cell foam, (2) a waterproof layer on one side of the insulating layer, and (3) an optional protective layer on the side of the insulating layer opposite the waterproof layer. There may be one or more layers in addition to these layers, and any layer may either be a material, such as natural or synthetic cloth, or a coating applied to a membrane, such as a spray coating. Layers may or may not be attached to adjacent layers.

Each of the layers utilized in a composite material according to the invention is breathable to allow moisture to escape through the composite material to the outside. At least the waterproof layer is waterproof to prevent penetration by liquid water.

The insulating layer is an open cell foam and is preferably a polyurethane. Most preferably, the insulating layer is a thermoplastic polyurethane that can be re-shaped (preferably by a thermal molding process) after being formed. The waterproof layer is positioned on a side of the insulting layer towards the outside of the composite material, and is comprised of any suitable material, such as GORE-TEX. The optional protective layer is any suitable, breathable material that offers some protection to the insulating layer, and may be a fleece that wicks moisture.

In one preferred embodiment, the insulating layer is HYPUR-CEL polyurethane foam, the waterproof layer is expanded PTFE—GORE-TEX (positioned on one side of the insulating layer) and the protective layer is polyester fleece (positioned on the other side of the insulating layer). The resulting composite material could be used in place of neoprene in certain applications. The invention may be used in numerous outdoor covering applications (such as for fishing, biking, backpacking, hiking, or camping). Additional potential markets are military applications (e.g., uses for the Navy) and other commercial or consumer clothing applications such as for offshore oil and gas rigs, underwater salvage, sport and commercial diving, commercial logging, sport and commercial fishing, boating, shipping, emergency response, homeland security and other such applications in which the finished product (whether it is a garment, covering, or other product) are subject to water, cold and/or generally inclimate weather. The composite material may be used in end products such as, but not limited to, fishing waders, waterfowl hunting waders, hunting gear, boots, shoes, socks, hats, gloves, outerwear (such as jackets, coats, pants, bib-overalls, or shells), dive suits, scuba suits, oil rig garments, sailing gear and clothing, horse blankets, dog coats, dog beds, kayak/canoe gear, waterproof mattress pads, tent and/or shelter fabrics, or seating cushions (for example, industrial, vehicle, automotive, office interior, or residential seating.)

Depending upon the particular embodiment of the invention, the invention may have additional benefits, such as an ergonomic fit because the foam utilized as the insulator can preferably be formed into shapes and may be stretchable, particularly if a thermoplastic (rather than thermoset) foam is utilized.

### BRIEF DESCRIPTION OF THE DRAWINGS

FIG. 1 is a cross-sectional view of an embodiment of the invention.

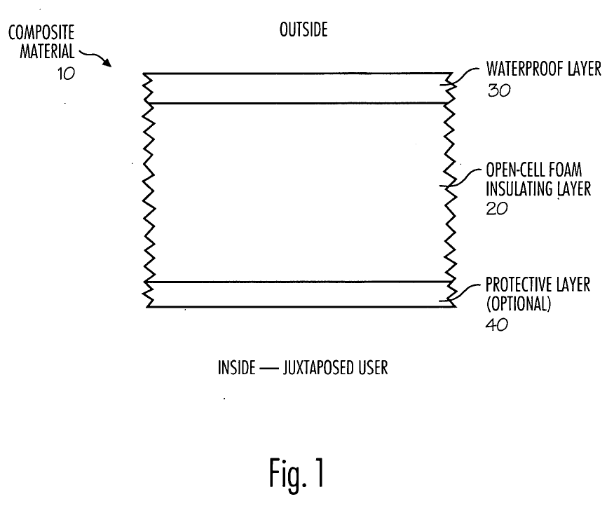

FIG. 2 is a cross-sectional view of an alternative embodiment of the invention.

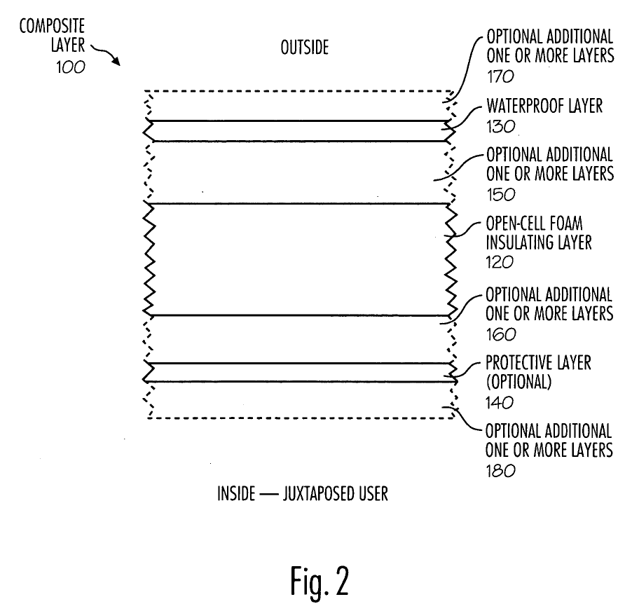

FIG. 3 is a cross-sectional view of an alternative embodiment of the invention.

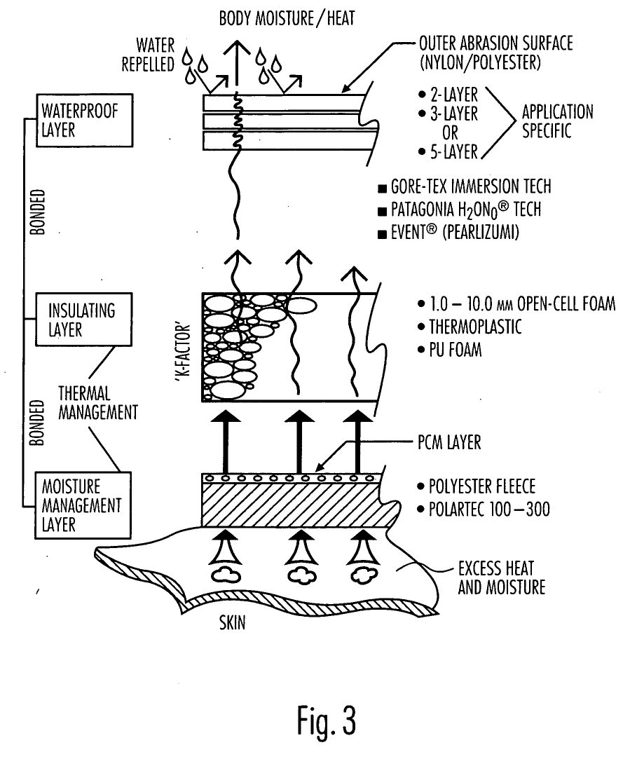

FIG. 4 is a cross-sectional view of an alternative embodiment of the invention.

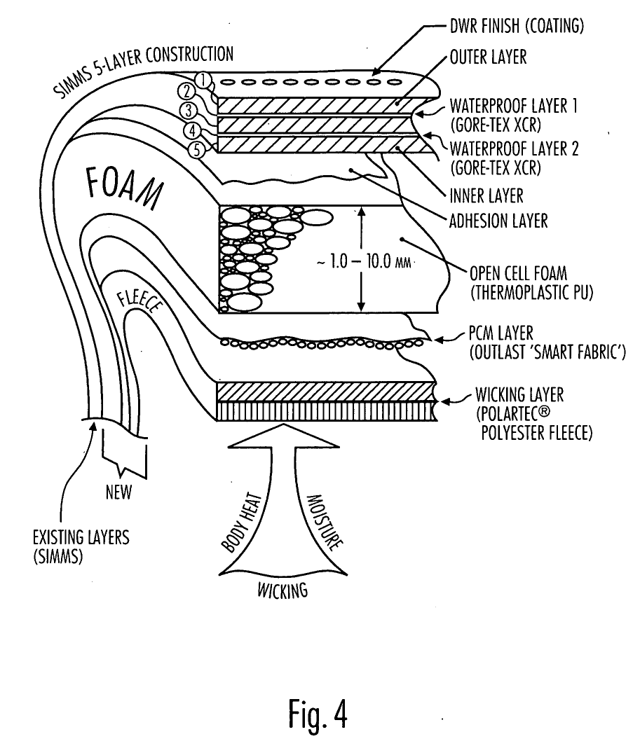

FIG. 5 includes charts showing the features of some layers that may be included in the invention.

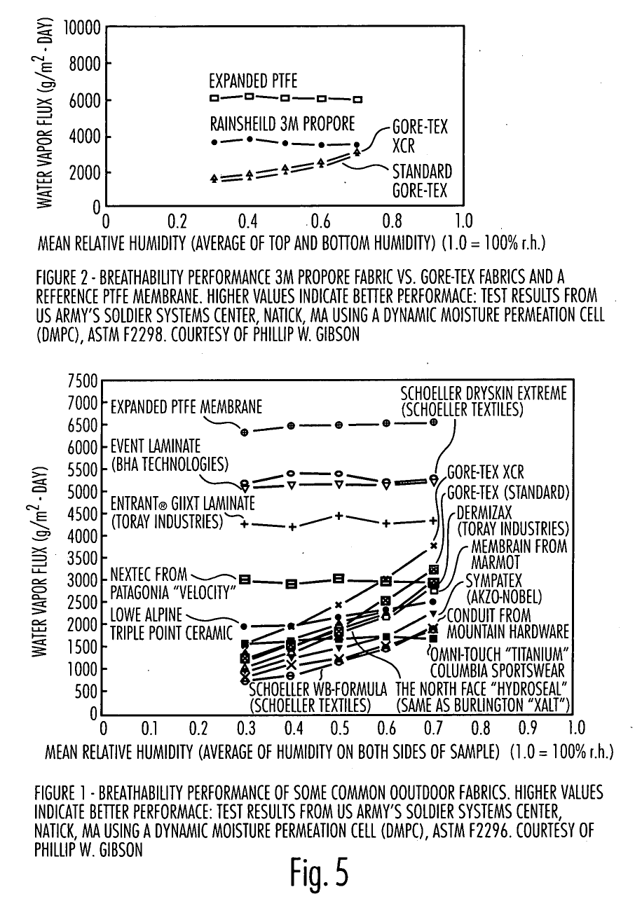

### DESCRIPTION OF PREFERRED EMBODIMENTS

The term “membrane” or “layer” as used herein means any one of a natural or synthetic fabric, foam, polymer, sheet, film and/or coating. The term “composite material” as used herein means a material constructed of a plurality (i.e., two or more) layers. Each of the various layers in a composite material may or may not be attached to an adjacent layer.

The term “breathable” as used herein means a membrane comprising a microporous substance that includes pores large enough to allow water vapor molecules (such as in the form of perspiration) to pass through, thus allowing them to move from one side of the membrane to the other (e.g., from the side closest to the user to the outside in order to vent perspiration). Quantatively, breathability is defined herein as any membrane with a water vapor flux greater than 800 gm/m² per 24 hours, using a Dynamic Moisture Permeation Cell (DMPC), per test method ASTM F2298. For some applications a vapor flux as high as 10,000 gm/m² per 24 hours may be desired.

The term “waterproof” as used herein means a membrane having micropores (up to millions per square foot) wherein the micropores are smaller than, and usually many times smaller than, a water droplet, thus preventing liquid water molecules from passing through the membrane. Quantatively, waterproof is defined herein as any membrane, such as a natural or synthetic fabric, that resists water penetration at a hydrostatic head of 1500 mm or greater. For some applications, a hydrastatic head rating of 10,000 mm or greater, or 28,000 mm or greater, or 45,000 mm or greater is desirable.

The invention comprises at least an insulating layer and a waterproof layer. Optionally, a protective layer and/or other layers may be included.

### Insulating Layer

The breathable, insulating layer (sometimes referred to herein simply as “insulating layer”) is an open cell foam that insulates and allows for the transmission of water vapor (such as perspiration) through the open-cell foam. The breathable, insulating layer is preferably constructed from an open-cell foam of a thickness ranging from 0.30 mm to 25.0 mm, although any suitable thickness may be used, depending upon the type of foam and the application for which the resulting composite material will be used.

The breathable, insulating layer may optionally be of a type that, after being formed, could be molded or otherwise reformed into a 3-dimensional or 2-dimesional configuration to provide added function such as better fit, added or improved functionality, or ease of manufacturing a finished product including the insulating layer. For example, if the composite material were to be used in waders, insulating layer could be first manufactured in sheets and later reformed) to the proper configuration for the boot portion of the wader. If reformed after first being manufactured, the insulating layer may be reformed using any suitable process, such as, but not limited to, thermoforming, thermal-molding, vacuum forming, and/or pressure forming.

Alternatively, the insulating layer could be initially manufactured (rather than being reformed) in the proper configuration, such as the configuration of a boot or padded knee articulation (pre-creased for ease of bending), or after being initially manufactured could be cut and/or pieced into the proper configuration.

The breathable, insulating layer is an open-cell foam that is preferably, but not necessarily, a thermoplastic. The layer could also be or include an open cell thermoset material. The most preferred material is a polyurethane (either thermoplastic or thermoset) foam. In preferred embodiments, the breathable, insulating layer comprises one or more of the following: (a) HYPUR-CEL T-Series open-cell polyether-based, thermal formable polyurethane foam from Rubberlite, Inc. (Huntington, W. Va.); (b) HYPUR-CEL S-Series open-cell polyester-based, high elongation thermal formable polyurethane foam from Rubberlite, Inc. (Huntington, W. Va.); (c) HYPUR-CEL H-Series open-cell hybrid polymer, high temperature, non-thermal formable polyurethane foam from Rubberlite, Inc. (Huntington, W. Va.); (d) VISCO-CEL (to include grades VO517, VO525, VO533) open-cell non-thermal formable, visio-elastic polyurethane foam from Rubberlite, Inc. (Huntington, W. Va.); (e) Estane polyether-based open-cell, thermoplastic polyurethane (TPU) foam from Noveon, Inc., a subsidiary of The Lubrizol Corporation (Wickliffe, Ohio); (f) Estane polyester-based open-cell, thermoplastic polyurethane (TPU) foam from Noveon, Inc., a subsidiary of The Lubrizol Corporation (Wickliffe, Ohio); (g) an open-cell polyurethane foam from E-A-R Specialty Composites, Inc., a subsidiary of the Aeraro Company, Inc. (Indianapolis, Ind.); (h) an open-cell polyurethane foam (series 10000, 12000, 19000) from Pro-Tac Industries, Inc. (Quebec, Calif.).

Following are the properties of some open-cell foams that may be used to practice the invention:

TYPICAL PROPERTIES OF HYPUR-CEL - T0503
(Polyurethane Foam)

| | |
|---|---|
| Flammability | |
| FMVSS-302 | PASS (.078″ OR THICKER)¹ |

| | TEST | UNIT OF | |
|---|---|---|---|
| PHYSICAL PROPERTY | METHOD | MEASURE | RESULT |
| DENSITY | ASTM D3574 | PCF | 3.5-6.5 |
| HARDNESS | ASTM D2240 | SHORE 0 | 4 |
| TENSILE STRENGTH | ASTM D3574 | PSI | 45 |
| ELONGATION | ASTM D3574 | PSI | 100 |
| TEAR STRENGTH | ASTM D624 | LB/IN | 5 (Min) |
| COMPRESSION SET | ASTM D1056 | % | 3 (Max) |
| 50% - 22 HRS @ 73° F. | | | |
| COMPRESSION SET | ASTM D3574 | % | — |
| 50% - 22 HRS @ 158° F. | | | |
| COMPRESSION FORCE | ASTM D3574 | PSI | 1-5 |
| DEFLECTION 25% | | | |
| COMPRESSION | ASTM D1056 | PSI | 1-5 |
| DEFLECTION @25% | | | |
| COLOR | N/A | N/A | GREY |

TYPICAL PROPERTIES OF HYPUR-CEL - T0812
(Polyurethane Foam)

| | |
|---|---|
| Flammability | |
| FMVSS-302 | PASS (.078″ OR THICKER)¹ |

| | TEST | UNIT OF | |
|---|---|---|---|
| PHYSICAL PROPERTY | METHOD | MEASURE | RESULT |
| DENSITY | ASTM D3574 | PCF | 6.5-9.5 |
| HARDNESS | ASTM D2240 | SHORE 0 | 20 |
| TENSILE STRENGTH | ASTM D3574 | PSI | 75 (MIN) |
| ELONGATION | ASTM D3574 | % | 50 (MIN) |
| TEAR STRENGTH | ASTM D624 | LB/IN | 5 (MIN) |
| COMPRESSION SET | ASTM D1056 | % | 3 (MAX) |
| 50% - 22 HRS @ 73° F. | | | |
| COMPRESSION SET | ASTM D3574 | % | — |
| 50% - 22 HRS @ 158° F. | | | |
| COMPRESSION FORCE | ASTM D3574 | PSI | 5-9 |
| DEFLECTION 25% | | | |
| COMPRESSION | ASTM D1056 | PSI | 9-15 |
| DEFLECTION | | | |
| @ 25% | | | |
| COLOR | N/A | N/A | BLACK |

TYPICAL PROPERTIES OF HYPUR-CEL - T2040
(Polyurethane Foam)

| | |
|---|---|
| Flammability | |
| FMVSS-302 | PASS (.063″ OR THICKER)¹ |

| | TEST | UNIT OF | |
|---|---|---|---|
| PHYSICAL PROPERTY | METHOD | MEASURE | RESULT |
| DENSITY | ASTM D3574 | PCF | 17-23 |
| HARDNESS | ASTM D2240 | SHORE 0 | 40 |
| TENSILE STRENGTH | ASTM D3574 | PSI | 150 (MIN) |
| ELONGATION | ASTM D3574 | % | 120 (MIN) |
| TEAR STRENGTH | ASTM D624 | LB/IN | 25 (MIN) |
| COMPRESSION SET | ASTM D1056 | % | 3 (MAX) |
| 50% - 22 HRS @ 73° F. | | | |
| COMPRESSION SET | ASTM D3574 | % | — |
| 50% - 22 HRS @ 158° F. | | | |
| COMPRESSION FORCE | ASTM D3574² | PSI | 19-25 |
| DEFLECTION 25% | | | |
| COMPRESSION | ASTM D1056 | PSI | 30-50 |
| DEFLECTION | | | |
| @ 25% | | | |
| COLOR | N/A | N/A | BLACK |

TYPICAL PROPERTIES OF HYPUR-CEL - T0805
(Polyurethane Foam)

| | |
|---|---|
| Flammability | |
| FMVSS-302 | PASS (.078″ OR THICKER)¹ |

| | TEST | UNIT OF | |
|---|---|---|---|
| PHYSICAL PROPERTY | METHOD | MEASURE | RESULT |
| DENSITY | ASTM D3574 | PCF | 6.5-9.5 |
| HARDNESS | ASTM D2240 | SHORE 0 | 7 |
| TENSILE STRENGTH | ASTM D3574 | PSI | 65 (MIN) |
| ELONGATION | ASTM D3574 | % | 100 (MIN) |
| TEAR STRENGTH | ASTM D624 | LB/IN | 6 (MIN) |
| COMPRESSION SET | ASTM D1056 | % | 3 (MAX) |
| 50% - 22 HRS @ 73° F. | | | |
| COMPRESSION SET | ASTM D3574 | % | — |
| 50% - 22 HRS @ 158° F. | | | |
| COMPRESSION FORCE | ASTM D3574 | PSI | 2-6 |
| DEFLECTION 25% | | | |
| COMPRESSION | ASTM D1056 | PSI | 3-7 |
| DEFLECTION | | | |
| @ 25% | | | |
| COLOR | N/A | N/A | Grey |

TYPICAL PROPERTIES OF HYPUR-CEL - S0702
(Polyurethane Foam)

| | |
|---|---|
| Flammability | |
| FMVSS-302 (TESTED AT .500″) | PASS |

| | TEST | UNIT OF | |
|---|---|---|---|
| PHYSICAL PROPERTY | METHOD | MEASURE | RESULT |
| DENSITY | ASTM D3574 | PCF | 5.5-8.5 |
| HARDNESS | ASTM D2240 | SHORE 0 | 0 |
| TENSILE STRENGTH | ASTM D3574 | PSI | 60 (MIN) |
| ELONGATION | ASTM D3574 | % | 250 (MIN) |
| TEAR STRENGTH | ASTM D624 | LB/IN | 8 (MIN) |
| COMPRESSION SET | ASTM D1056 | % | 5 (MAX) |
| 50% - 22 HRS @ 73° F. | | | |
| COMPRESSION SET | ASTM D3574 | % | — |
| 50% - 22 HRS @ 158° F. | | | |
| COMPRESSION FORCE | ASTM D3574 | PSI | .5-3 |
| DEFLECTION 25% | | | |
| COMPRESSION | ASTM D1056 | PSI | .5-3.5 |
| DEFLECTION | | | |
| @ 25% | | | |
| COLOR | N/A | N/A | Dark |
| | | | Blue |

TYPICAL PROPERTIES OF HYPUR-CEL - S1203
(Polyurethane Foam)

| | |
|---|---|
| Flammability | |
| FMVSS-302 (TESTED AT .500″) | PASS |

| | TEST | UNIT OF | |
|---|---|---|---|
| PHYSICAL PROPERTY | METHOD | MEASURE | RESULT |
| DENSITY | ASTM D3574 | PCF | 10-14 |
| HARDNESS | ASTM D2240 | SHORE 0 | 5 |
| TENSILE STRENGTH | ASTM D3574 | PSI | 90 (MIN) |
| ELONGATION | ASTM D3574 | % | 300 (MIN) |
| TEAR STRENGTH | ASTM D624 | LB/IN | 15 (MIN) |
| COMPRESSION SET | ASTM D1056 | % | 3 (MAX) |
| 50% - 22 HRS @ 73° F. | | | |
| COMPRESSION SET | ASTM D3574 | % | — |
| 50% - 22 HRS @ 158° F. | | | |
| COMPRESSION FORCE | ASTM D3574 | PSI | 1-5 |
| DEFLECTION 25% | | | |
| COMPRESSION | ASTM D1056 | PSI | 1-5 |
| DEFLECTION | | | |
| @ 25% | | | |
| COLOR | N/A | N/A | BLACK |

TYPICAL PROPERTIES OF HYPUR-CEL - T1515
(Polyurethane Foam)

| | |
|---|---|
| Flammability | |
| FMVSS-302 | PASS (.063″ OR THICKER)¹ |

| | TEST | UNIT OF | |
|---|---|---|---|
| PHYSICAL PROPERTY | METHOD | MEASURE | RESULT |
| DENSITY | ASTM D3574 | PCF | 13-17 |
| HARDNESS | ASTM D2240 | SHORE 0 | 22 |
| TENSILE STRENGTH | ASTM D3574 | PSI | 120 (MIN) |
| ELONGATION | ASTM D3574 | % | 150 (MIN) |
| TEAR STRENGTH | ASTM D624 | LB/IN | 15 (MIN) |
| COMPRESSION SET | ASTM D1056 | % | 3 (MAX) |
| 50% - 22 HRS @ 73° F. | | | |
| COMPRESSION SET | ASTM D3574 | % | — |
| 50% - 22 HRS @ 158° F. | | | |
| COMPRESSION FORCE | ASTM D3574 | PSI | 5-11 |
| DEFLECTION 25% | | | |
| COMPRESSION | ASTM D1056 | PSI | 12-18 |
| DEFLECTION | | | |
| @ 25% | | | |
| COLOR | N/A | N/A | BLACK |

Some differences of the afore-mentioned HYPUR-CEL foams and some other foams are as follows:

(1) Thermoplastic vs. thermoset—HYPUR-CEL can be thermoformed or molded into custom shapes, as compared with typical thermoset foam that is often only available as sheet stock, cut from a larger bun;

(2) open cell foam vs. closed cell—HYPUR-CEL can be manufactured to be breathable due to its open cell structure;

(3) HYPUR-CEL foam can utilize a polyurethane-based adhesive that is porous and may be used to bond, or laminate the foam to other materials without inhibiting the breathability of the resulting composite. In this manner a foam insulating layer can be bonded to Lycra, polyester, nylon, PTFE, and/or other materials, while maintaining breathability.

The breathable, insulating layer may be attached to other layers in any manner such as by ultrasonic welding, stitching, chemical lamination, thermal lamination, thermal welding, or a cross-linking lamination. Further, the insulating layer need not be attached to an adjacent layer.

The insulating layer of open-cell foam may also serve as an energy absorbing layer due to inherent properties of specific foam selected. The insulating layer might serve to protect against shock, vibration, impacts, and in general, absorb energy. The insulating layer could optionally be perforated with one or more openings to provide greater flow of air and water vapor and/or to create a lighter weight construction.

The insulating layer described herein could be constructed of multiple sub-layers of open-cell foam (thermoplastic and/or thermoset in any combination), wherein each sub-layer could provide a specific characteristic, such as providing thermal performance, a certain porosity or density, or being energy absorbing. One possible construction of such an insulating layer comprising sub-layers would be an insulating layer with two sub-layers of Rubberlite open-cell polyurethane foam, e.g., HYPUR-CEL (thermoplastic/thermoformable) and one sub-layer of VISCO-CEL (thermoset/non-thermoformable). In this embodiment, the HYPUR-CEL would provide a formability characteristic, since after it is manufactured it can be re-shaped (hereafter, “reformed”) utilizing thermoforming techniques. The VISCO-CEL sub-layer would provide the characteristic of being energy absorbing and shock attenuating. By combining the two, the VISCO-CEL sub-layer may be retained in a shape to which the HYPUR-CEL sub-layer is reformed. Both of these foams are open-cell and provide an insulating function. However, the HYPUR-CEL layer would be the major insulator and the VISCO-CEL would be the major energy absorber. These sub-layers could be bonded via an adhesive that is itself open-cell and hence air permeable, or otherwise be retained as part of a material according to the invention in any suitable manner.

### Waterproof Layer

The breathable, waterproof layer may be a single layer of a uniform substance or may be comprised of sub-layers of different substances to provide enhanced function or a combination of functions, e.g., being waterproof while under immersion, stretchable to provide elasticity, lightweight, and/or extended performance under demanding applications.

The breathable, waterproof layer utilized in the composite material might comprise, but is not limited to, one or more of (a) Musto HPX from Musto Ltd. (Essex, England, UK); (b) Hydrodry P3, or similar formulation, a hydrophilic laminate from Sprayway, Inc. (Manchester, England, UK); (c) Drilite Extreme (DLE), a monolithic, hydrophilic, highly waterproof/breathable and stretchable laminate from Mountain Equipment; (d) HyVent, a polyurethane waterproof/breathable membrane from The North Face, Inc. (San Leandro, Calif.); (e) eVENT, a hydrophobic expanded Polytetrafluoroethylene (ePTFE) and oleophobic membrane from Pearl Izumi, Inc., a subsidiary of Nautilus, Inc. (Vancouver, Wash.); (f) a polymer membrane made from expanded Polytetrafluoroethylene (ePTFE); (g)GORE-TEX ePTFE from W.L. Gore & Associates, Inc. (Newark, Del.); (h) GORE-TEX WINDSTOPPER ePTFE from W.L. Gore & Associates, Inc. (Newark, Del.); (i) GORE-TEX XCR ePTFE; GORE-TEX Classic 2-Layer ePTFE; 0) GORE-TEX Classic 3-Layer ePTFE; (k) GORE-TEX PacLite ePTFE; (1) GORE-TEX Immersion Technology ePTFE; (m) GORE-TEX Ocean Technology ePTFE; (n) H2No waterproof/breathable coating from Patagonia, Inc.; (o) Teslin waterproof/breathable silica-filled porous synthetic film from PPG Industries, Inc.; (p) Breeze Dry-Tec, a waterproof/breathable microporous membrane from Mont-Bell (Osaka, Japan); (q) Dry-Tec, a waterproof/breathable microporous membrane from Mont-Bell (Osaka, Japan); (r) Dry Lite Tec, a waterproof/breathable microporous polyurethane coating from Mont-Bell (Osaka, Japan); or (s) Hydro Breeze, a waterproof/breathable multi-layer microporous polyurethane coating from Mont-Bell (Osaka, Japan), Super Hydro Breeze, a waterproof/breathable multi-layer microporous polyurethane coating from Mont-Bell (Osaka, Japan).

The breathable, waterproof function may also be derived from the use of a breathable coating, such as a thin layer of resin, applied to a fabric. The breathable coating could be of any suitable type (such as microporous or hydrophilic) or types. Such a breathable, waterproof coating may be TriplePoint Ceramic, a multi-layer waterproof microporous coating from Lowe Alpine, Hydrodry P2, a mixture of hydrophilic coatings and laminates from Sprayway, Inc. (Manchester, England, UK), Entrant II, a multi-layer microporous waterproof coating, or Aquadry (a hydrophobic, multi-layer microporous waterproof coating from Craghopper.)

### Optional Protective Layer

The invention also includes an optional protective layer between the insulating layer and the inner surface of the product that utilizes a composite material according to the invention. The protective layer is preferably a fabric, such as fleece, or could be flocking adhesively bonded to the insulating layer, or could be a spray coating on the insulating layer. One purpose of the protective layer is to protect the insulating layer against abrasion while a finished product including a composite material according to the invention is in use. Optionally, the protective layer could provide a moisture management function by wicking, or transporting, excess water vapor (perspiration) away from the user's body through the multi-layer composite material to the outside, and/or provide added comfort to the user. In that case, if the invention were used as a garment, the protective layer would be on the inside next to the user. Further, the purpose of a layer next to the user could simply be to wick moisture and/or provide added comfort, rather than protect the insulating layer. A wicking layer would provide and assist in transporting water vapor (such as perspiration) away from the user's body and through the composite to the outside of the material. Such a layer, whether used to protect the insulating layer or simply to provide a wicking function and/or comfort may include a moisture-wicking material such as a polyester fleece, for example, PolarTec (manufactured by Malden Mills Industries, Inc.). In that case, this layer would preferably be the surface closest to the user's body.

For some applications, the protective layer is not required. Further, the open cell foam used as the insulating layer could be durable enough such that a separate protective layer is not required.

### Optional Phase Change Materials and Other Optional Agents

The composite material may include any number of layers other than the insulating layer and waterproofing layers. As previously described, the composite material might include a protective layer or simply a layer to provide moisture wicking and/or comfort to a user.

Additionally, the composite material according to the invention could include an outer face layer to provide or add abrasion protection and/or a specific appearance. The outer face layer could be of a specific color and/or pattern to meet a specific look or function and may be dye sublimation printed to add a specific color, and or pattern to the outer shell for the purposes of decoration, aesthetics or functions such as camouflage. For example, the outer layer of the composite material may be printed with a RealTree camouflage pattern from Jordan Outdoor Enterprises, Ltd. (Columbus, Ga.), an Advantage camouflage pattern from Jordan Outdoor Enterprises, Ltd. (Columbus, Ga.), or a MossyOak camouflage pattern from Haas Outdoors, Inc. (West Point, Mass.), a Predator camouflage pattern from Predator, Inc. (LaCrosse, Wis.), or a Tru-Woods camouflage pattern from Miller Outdoors, Inc. (Stowe, Pa.).

The outer, or face, layer may, after being applied, be treated with a durable water repellent (DWR) coating, which could be a polymer coating.

The outer layer could also be a synthetic fabric comprised of nylon, nylon blend, nylon weave, ballistic nylon, polyester, and/or aramid polymer fiber such as, but not limited to, KEVLAR.

The composite material may also incorporate phase change material (PCM) for the purpose of thermal management. The PCM could act as a heat reservoir, by absorbing and storing excess body heat as it is generated and then releasing the excess heat when it is needed. The PCM could be incorporated as a coating or in situ to the fibers of any suitable layer. Such a PCM could be Outlast from Outlast Technologies, Inc. (Boulder, Colo.), or Smart Fabric Technology from Outlast Technologies, Inc. (Boulder, Colo.).

The multi-layer composite construction could also incorporate antimicrobial agents, organic or inorganic, integral to the materials, as a coating or in situ to fabric fibers for the purposes of controlling bacteria.

### Conclusion

The present invention provides a new level of functionality in material construction that can be incorporated in a wide variety of applications.

Having thus described different embodiments of the invention, other variations and embodiments that do not depart from the spirit of the invention will become apparent to those skilled in the art. The scope of the present invention is thus not limited to any particular embodiment, but may be instead set forth in the appended claims and the legal equivalents thereof. Unless expressly stated in the written description or claims, the steps of any method recited in the claims may be performed in any order capable of yielding the desired product.

What is claimed is:

1. A waterproof, breathable, insulated composite material comprising (a) an insulating layer of open-cell foam, the insulating layer having a first side and a second side, (b) a protective layer positioned on the first side of the insulating layer, and (c) a waterproof layer positioned on the second side of the open-cell foam.

2. The material of claim 1 wherein the protective layer is fleece.

3. The material of claim 1 wherein the waterproof layer comprises GORE-TEX.

4. The material of claim 1 that further comprises at least one additional layer between the insulating layer and the waterproof layer.

5. The material of claim 1 that further includes at least one additional layer between the insulating layer and the protective layer.

6. The material of claim 1 wherein the insulating layer is a polyurethane foam.

7. The covering of claim 1 wherein the insulating layer is a thermoplastic material.

8. The material of claim 6 wherein the polyurethane foam is a thermoplastic material.

9. The covering of claim 1 wherein the insulating layer can be molded after being formed.

10. The material of claim 6 wherein the polyurethane can be molded after being formed.

11. The material of claim 8 wherein the polyurethane can be molded after being formed.

12. The material of claim 6 wherein the polyurethane is HYPUR-CEL T0503.

13. The material of claim 1 wherein the thickness of the insulating layer is between 0.30 mm and 25.0 mm

14. The material of claim 1 wherein the protective layer is attached directly to the insulating layer.

15. The material of claim 14 wherein the protective layer is attached to the insulating layer by an adhesive.

16. The material of claim 14 wherein the protective layer is attached to the insulating layer by heat welding.

17. The material of claim 1 wherein the waterproof layer is attached directly to the insulating layer.

18. The material of claim 17 wherein the waterproof layer is attached to the insulating layer by an adhesive.

19. The material of claim 17 wherein the waterproof layer is attached to the insulating layer by heat welding.

20. The material of claim 1 that further includes an outer face layer adjacent the waterproof layer.

21. The material of claim 20 wherein the outer face material has a pattern thereon.

22. Waders formed of the material of claim 1.

23. A boot formed of the material of claim 1.

24. The material of claim 6 wherein the insulating layer is between 0.30 mm and 25.0 mm thick.

25. The material of claim 6 wherein the polyurethane is selected from one or more of the group consisting of: HYPUR-CEL T0812, HYPUR-CEL T2040, HYPUR-CEL T0805, HYPUR-CEL S0702, HYPUR-CEL S1203, HYPUR-CEL T1515.
